(19) United States
(12) Patent Application Publication
(10) Pub. No.: US 2022/0103693 A1
(43) Pub. Date: Mar. 31, 2022

(54) INFORMATION PROCESSING APPARATUS, REPLY PROCESSING APPARATUS, INFORMATION PROCESSING SYSTEM, AND NON-TRANSITORY COMPUTER READBLE MEDIUM

(71) Applicant: FUJIFILM BUSINESS INNOVATION CORP., Tokyo (JP)

(72) Inventor: Kenji AKIBA, Kanagawa (JP)

(73) Assignee: FUJIFILM BUSINESS INNOVATION CORP., Tokyo (JP)

(21) Appl. No.: 17/149,869

(22) Filed: Jan. 15, 2021

(30) Foreign Application Priority Data
Sep. 25, 2020 (JP) 2020-161015

(51) Int. Cl. H04M 15/04; H04M 3/42; H04M 3/537; G10L 15/26

(52) U.S. Cl. CPC H04M 15/04; G10L 15/26; H04M 3/537; H04M 3/42221

(57) ABSTRACT

An information processing apparatus includes a memory storing a log of an operation of a user and a processor configured to cause the memory to store the log of the operation of the user, and if the log of the operation of the user stored on the memory satisfies a specific condition after an operation related to an inquiry of the user is detected, transmit, to an external entity related to a destination of the inquiry, information indicating that a question in the inquiry of the user is not solved.

### CROSS-REFERENCE TO RELATED APPLICATIONS

This application is based on and claims priority under 35 USC 119 from Japanese Patent Application No. 2020-161015 filed Sep. 25, 2020.

### BACKGROUND

### (i) Technical Field

The present disclosure relates to an information processing apparatus, a reply processing apparatus, an information processing system, and a non-transitory computer readable medium.

### (ii) Related Art

Japanese Unexamined Patent Application Publication No. 2006-126966 discloses a call center system that accurately records a variety of inquiries and conversations performed between customers and operators at a call center and provides a quick service to the customers. The call center system includes a converter unit, a conversation database (DB) unit, and an association DB unit. The converter unit converts voice data including a conversation between a customer and an operator into text data through a voice recognition system. The conversation DB unit stores on a conversation DB the text data and the voice data in association with each other. The association DB unit stores as log data a log of conversations between the customer and the operator by reading customer identification (ID) data, operator ID data, and date data that identifies with a timer unit a date on which the conversation has been performed between the customer and the operator and by associating the text data recorded on the conversation DB with the voice data.

A user may make an inquiry and receive a reply to the inquiry. Even when the user has gained the reply, this does not necessarily solve the question in the inquiry. An answering side has difficulty in determining whether the user has solved the question.

### SUMMARY

Aspects of non-limiting embodiments of the present disclosure relate to providing an information processing apparatus, a reply processing apparatus, an information processing system, and a non-transitory computer readable medium transmitting, to an inquiry destination, information indicating that a question in an inquiry is not solved in a reply from the inquiry destination if the question in the inquiry of the user is not clarified.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory storing a log of an operation of a user and a processor configured to cause the memory to store the log of the operation of the user, and if the log of the operation of the user stored on the memory satisfies a specific condition after an operation related to an end of an inquiry of the user is detected, transmit, to an external entity related to a destination of the inquiry, information indicating that a question in the inquiry of the user is not solved.

### BRIEF DESCRIPTION OF THE DRAWINGS

Exemplary embodiment of the present disclosure will be described in detail based on the following figures, wherein:

FIG. 1 illustrates a conceptual modular configuration of a structure of an exemplary embodiment;

FIG. 2 illustrates a conceptual modular configuration of a structure of an exemplary embodiment;

FIG. 3 illustrates an example of a system configuration of the exemplary embodiment;

FIG. 4 is a flowchart illustrating a process example of the exemplary embodiment;

FIG. 5 is a flowchart illustrating a process example of the exemplary embodiment;

FIG. 6 illustrates a conceptual modular configuration of a customer terminal and a sales support system as a specific example of the exemplary embodiment;

FIG. 7 is a flowchart illustrating a process example of the exemplary embodiment;

FIG. 8 is a flowchart illustrating a process example of the exemplary embodiment;

FIG. 9 is a flowchart illustrating a process example of the exemplary embodiment;

FIG. 10 is a flowchart illustrating a process example of the exemplary embodiment;

FIG. 11 is a flowchart illustrating a process example of the exemplary embodiment;

FIG. 12 is a flowchart illustrating a process example of the exemplary embodiment;

FIG. 13 is a flowchart illustrating a process example of the exemplary embodiment;

FIG. 14 is a flowchart illustrating a process example of the exemplary embodiment;

FIG. 15 is a flowchart illustrating a process example of the exemplary embodiment;

FIG. 16 is a flowchart illustrating a process example of the exemplary embodiment;

FIG. 17 illustrates a data structure of a web access information table;

FIG. 18 illustrates a data structure of a transmission web access information table;

FIG. 19 illustrates a data structure of a corporate information table;

FIG. 20 illustrates a data structure of a date of call start table;

FIG. 21 illustrates a data structure of a date of call end table;

FIG. 22 illustrates a data structure of a transmission call information table;

FIG. 23 illustrates a data structure of a web access information table;

FIG. 24 illustrates a data structure of an unsolved inquiry user web access information table;

FIG. 25 illustrates a display example of a verification screen;

FIG. 26 illustrates a data structure of an unsolved inquiry user web access information table;

FIG. 27 illustrates a data structure of an unsolved inquiry user list table;

FIG. 28 illustrates a data structure of a web access information table;

FIG. 29 illustrates a data structure of a phone information table;

FIG. 30 illustrates a data structure of a web access information table;

FIG. 31 illustrates a data structure of a phone information table;

FIG. 32 illustrates a data structure of a web access information table;

FIG. 33 illustrates a data structure of a corporate information table;

FIG. 34 illustrates an example of a web chat usage report created in accordance with the exemplary embodiment;

FIG. 35 illustrates an example of a phonebot usage report created in accordance with the exemplary embodiment;

FIG. 36 illustrates an example of a web access report after a call created in accordance with the exemplary embodiment;

FIG. 37 illustrates an example of a report created in accordance with the exemplary embodiment; and

FIG. 38 illustrates a conceptual modular configuration of a structure of the exemplary embodiment.

### DETAILED DESCRIPTION

Exemplary embodiment of the present disclosure is described with reference to the drawings.

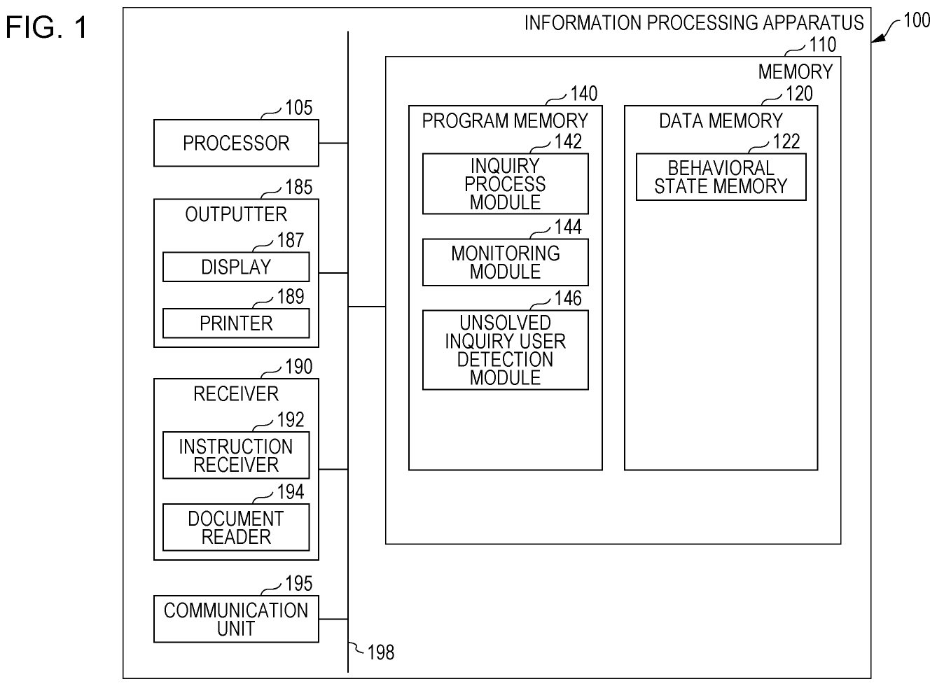

FIG. 1 illustrates a conceptual modular configuration of a structure of the exemplary embodiment.

The term “module” refers to a software component (including a computer program) that is logically separable, or a hardware component. The module of the exemplary embodiment refers to not only a module in a computer program but also a module in a hardware configuration. The discussion of the exemplary embodiment also serves as the discussion of a system, method, and computer program that causes the modules to function (including a program that causes a computer to execute each step, a program that causes the computer to function as an element, and a program that causes the computer to implement each function). In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be configured of one program or multiple modules may be configured of one program. One module may be configured of multiple programs. Multiple modules may be executed by a single computer. A single module may be executed by multiple computers in a distributed environment or a parallel environment. One module may include another module.

In the discussion that follows, the term “connection” refers to not only a physical connection but also a logic connection (such as an exchange of data, instructions, data reference relationship, or login).

The term “predetermined” means that something is decided in advance of a process of interest. The term predetermined is thus intended to refer to something that is decided in advance of a process of interest in the exemplary embodiment. Even after a process in the exemplary embodiment has started, the term predetermined refers to something that is decided in advance of a process of interest depending on a condition or a status of the exemplary embodiment at the present point of time or depending on a condition or status of the exemplary embodiment heretofore continuing down to the present point of time. If plural predetermined values are used, the predetermined values may be different from each other, or two or more of the predetermined values (including all the values) may be equal to each other.

A statement that “if A, B is to be performed” is intended to mean that a determination as to whether something is A is performed and that if something is determined as A, an action B is to be taken. The statement becomes meaningless if the determination as to whether something is A is not performed. If a discussion is made of events “A, B, and C,” the discussion is applicable to at least one of the events “A, B, and C” unless otherwise noted. For example, the discussion is applicable to the case in which only the event A is selected.

The term “system” or the term “apparatus” refers to an arrangement where multiple computers, a hardware configuration, and an apparatus are interconnected via a communication network (including a one-to-one communication connection). The term system or the term apparatus also refers to an arrangement that includes a single computer, a hardware configuration, and an apparatus. The term system and the term apparatus have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate.

The information processing apparatus 100 of the exemplary embodiment has a function of determining in response to an inquiry of a user whether a question in the inquiry of the user has been solved. Referring to FIG. 1, the information processing apparatus 100 includes, at least, a processor 105, memory 110 and bus 198 that connects these elements to exchange data. The information processing apparatus 100 may further include an outputter 185, receiver 190, and communication unit 195. Data is also exchanged via the bus 198 from one to another element among the processor 105, memory 110, outputter 185, receiver 190, and communication unit 195. The information processing apparatus 100 is used to support a contact center and sales operation in view of an action responsive to customer dissatisfaction.

The block diagram in FIG. 1 also indicates a hardware configuration of a computer that implements the exemplary embodiment. The hardware configuration of the computer that executes a program of the exemplary embodiment is a computer illustrated in FIG. 1. Specifically, the hardware configuration is a personal computer or a computer that may be used as a server. Specifically, the processor 105 and memory 110 are used as a processing unit and a storage device, respectively.

One or more processors 105 may be used. The processor 105 may include a central processing unit (CPU) or a microprocessor. If multiple processors 105 are used, they are tightly coupled or loosely coupled. For example, a single processor 105 may include multiple processor cores. Multiple computers are coupled as a system that virtually functions as a single computer. Specifically, a loosely coupled multi-processor may be configured as a cluster system or a computer cluster. The processor 105 executes a program on a program memory 140.

The memory 110 may include a semiconductor memory, such as a register or a cache memory, in the processor 105 or a memory, such as a random-access memory (RAM) or a read-only memory (ROM). The memory 110 may also be an internal memory device, such a hard disk drive (HDD) or a solid-state drive (SSD), each functioning as a persistent memory, or an external memory device or an auxiliary memory device, such as a compact disc (CD), or digital versatile disc (DVD), Blu-ray (registered trademark) disc, universal serial bus (USB) memory, memory card or other external storage device or other auxiliary memory device. The memory 110 may also be a memory device of a server connected to the information processing apparatus 100 via a communication network.

The memory 110 includes a data memory 120 storing data and a program memory 140 storing programs. The data memory 120 and the program memory 140 may store programs of the modules illustrated in FIG. 1, programs such as an operating system to start up the computer, and data, such as parameters that appropriately vary in the execution of the modules.

The outputter 185 includes a display 187 and printer 189. The display 187 may be a liquid-crystal display, organic electroluminescent (EL) display, or three-dimensional display and displays, in text or image, process results from the processor 105 and data on the data memory 120. The printer 189 may be a printer or a multi-function device and prints the process results from the processor 105 and data on the data memory 120. The outputter 185 may also include a speaker and actuator to vibrate the outputter 185.

The receiver 190 includes an instruction receiver 192 and a document reader 194. The instruction receiver 192 includes a keyboard, mouse, microphone, camera (including eye-gaze detection camera) or other device and receives data generated in response to user operation performed on these device (such as an action, voice, gaze of a user).

A touch screen serving the functions of both the display 187 and the instruction receiver 192 may be used. In such a case, without the physical presence of keys, the keyboard function may be implemented by drawing a keyboard (called a software keyboard or a screen keyboard) on the touch screen using software.

A display 187 and instruction receiver 192 are used as user interfaces.

The document reader 194, such as a scanner or camera, reads or photographs a document to create image data.

The communication device 195 is a communication network interface used to connect to another apparatus via a communication network.

The exemplary embodiment related to a computer program is implemented when the computer program as software is read onto the program memory 140 as a hardware resource and the software and hardware cooperate with each other. Specifically, to implement the exemplary embodiment, information processing based on software is performed by hardware resources (at least including the processor 105 and the memory 110 and in some cases further the outputter 185, receiver 190, and communication unit 195). The exemplary embodiment is thus implemented in accordance with the laws of nature.

The hardware configuration in FIG. 1 is illustrated for exemplary purposes only. The exemplary embodiment is not limited to the configuration illustrated in FIG. 1 and is acceptable as long as the configuration implements the modules of the exemplary embodiment. For example, the processor 105 may include a graphics processing unit (GPU) (including general-purpose computing on graphics processing unit (GPGPU)). Part of the modules may be implemented by a dedicated hardware resource (such as application specific integrated circuit (ASIC)) or field-programmable gate array (FPGA) that is a reconfigurable integrated circuit. Part of the modules may be in an external system that is connected via a communication network. Multiple of the system in FIG. 1 may be operatively coupled via a communication network. The system in FIG. 1 may be incorporated in a personal computer, portable information communication apparatus (such as cellular phone, smart phone, mobile device, or wearable computer), information appliance, robot, copier, fax, scanner, printer, or multi-function apparatus (an image processing apparatus having at least two of scanner function, printer function, copier function, and fax function).

The processor 105 is connected to the memory 110, outputter 185, receiver 190, and communication device 195 via the bus 198. The processor 105 executes a process in accordance with the computer program that describes an execution sequence of each module and stored on the program memory 140. For example, in response to an event when the instruction receiver 192 receives user operation, the processor 105 performs the process of a module responsive to the event on the program memory 140, causes the data memory 120 to store the process results, outputs the process results to the display 187, or transmits the process results to another apparatus by controlling the communication device 195.

The memory 110 includes the data memory 120 and program memory 140 and is connected to the processor 105, outputter 185, receiver 190, and communication device 195 via the bus 198.

The data memory 120 includes a behavioral state memory 122.

The behavioral state memory 122 stores a log of operations of a user who uses the information processing apparatus 100.

The program memory 140 includes an inquiry process module 142, monitoring module 144, and unsolved inquiry user detection module 146.

The inquiry process module 142 performs an inquiry process of a user on the information processing apparatus 200. Specifically, the inquiry process module 142 causes a conversation to be performed between a user and an external entity. The conversation may be a voice or text. The voice may be used on phones (including softphone). The text may be chat. Specifically, the inquiry process module 142 performs a user inquiry to an external entity and receives a reply responsive to the inquiry. If the inquiry is performed in text, the display 187 is controlled to display the inquiry as a log and a sentence as the reply.

An inquiry destination may be human or robot.

If the inquiry destination is a robot, the reply in the conversation is performed by an entity other than human. For example, the conversation may be performed an artificial intelligence (AI) model which has machine-learned the conversations. Specifically, a chatbot or phonebot is used.

The reply responsive to the inquiry may performed by an entity other than the robot, namely, by human. If the answerer is an expert or the answerer is a person whose native language is different from that of the inquirer, a question in the inquiry may possibly be not solved. In such a case, the information processing apparatus 100 may be used. In such a case, a condition that is satisfied when the information processing apparatus 100 is used is that “access destinations specified in the log of the operations of the user include an inquiry destination.” The condition may also be that “the user inquiry indicates a request that a present person in charge of the user be replaced with another person or the user inquiry includes a word indicating dissatisfaction (such as, “unsolved” or “frustrated”).”

When a robot is used to reply to the inquiry, the robot may have difficulty in determining “whether the user question is solved”. In the discussion that follows, the reply is performed by the robot.

The monitoring module 144 monitors the operation of the user and causes the behavioral state memory 122 to store the operation of the user as a log. For example, the monitoring module 144 may detect an operation related to the end of the inquiry of the user. Specifically, the monitoring module 144 detects the end of use of softphone or chat. The monitoring module 144 detects not only the end of the inquiry but also other operation of the user. For example, the monitoring module 144 detects an operation related to a web browser.

The unsolved inquiry user detection module 146 determines whether a question of the user is solved in the conversation between the user and the external entity. If the log of an operation of the user (user operation) stored on the behavioral state memory 122 meets a predetermined condition after the monitoring module 144 detects an operation related to the end of the inquiry of the user (user inquiry), the unsolved inquiry user detection module 146 transmits, to an external entity related to an inquiry destination, information indicating that the question in the user inquiry remains unsolved. Concerning the “external entity related to the inquiry destination,” the inquiry destination may be the “external entity” or the inquiry destination is an “external entity” that manages the inquiry destination. Typically, the former case is that the inquiry is replied by the robot and the latter case is that the inquiry is replied by human. Even when the inquiry is replied by the robot, the external entity and the robot may be different and the external entity may be a server that manages the robot.

If the log of the user operation stored on the behavioral state memory 122 fails to meet the predetermined condition after the monitoring module 144 detects the operation related to the end of the user inquiry, the unsolved inquiry user detection module 146 may transmit, to the external entity related to the inquiry destination, information indicating that the question in the user inquiry is solved or may transmit nothing (neither information indicating that the question is not solved nor information indicating that the question is solved).

After the monitoring module 144 detects the operation related to the end of the user inquiry, (1) a determination as to whether the log of the user operation stored on the memory meets the predetermined condition is performed and (2) if the log meets the predetermined condition, the user transmits to the external entity related to the inquiry destination the information indicating that the question in the inquiry is not solved.

If the reply to the inquiry is performed by a robot, the condition may be that the access destination in the log of the user operations stored on the behavioral state memory 122 includes the inquiry destination. Another condition may be that the log in the user operations stored on the behavioral state memory 122 indicates that a word used in the inquiry or the reply is searched for by a web browser. In this case, the word used in the inquiry or the reply may be used by a predetermined number of times or more.

An additional condition may also be that a log of the user operations occurring after the end of the inquiry is also used as a determination target. For example, the condition is satisfied if an operation accessing a homepage of the inquiry destination is performed even after the inquiry has ended. This operation performed determines that the question in the inquiry of the user remains unsolved.

If the condition is satisfied, the unsolved inquiry user detection module 146 checks with the user to see whether the inquiry is solved. If a user reaction indicates an unsolved inquiry, the unsolved inquiry user detection module 146 may transmit the information indicating the unsolved inquiry. If the user reaction indicates a solved inquiry, information indicating that the inquiry has not solved is naturally not transmitted. If the user reaction indicates the solved inquiry, the information indicating that the inquiry has been solved may be transmitted or nothing may be transmitted at all.

If no reaction is received from the user within a predetermined period of time in the confirmation with the user, the unsolved inquiry user detection module 146 may transmit the information indicating that the inquiry has not been solved. If a reaction received from the user within the predetermined period of time indicates the unsolved inquiry, the information indicating that the inquiry has not been solved is transmitted. If a reaction received from the user within the predetermined period of time indicates the solved inquiry, the information indicating that the inquiry has been not solved is not transmitted but the information indicating that the inquiry has been solved is transmitted or nothing is transmitted at all.

The unsolved inquiry user detection module 146 may transmit to the external entity the information stored on the behavioral state memory 122 in addition to the information indicating that the inquiry has not been solved. Furthermore, the unsolved inquiry user detection module 146 may transmit to the external entity the log of inquiries and replies. Moreover, the unsolved inquiry user detection module 146 may transmit the information stored on the behavioral state memory 122 and the log of inquiries and replies to the external entity only when the information indicating that the inquiry has not been solved is transmitted. Even when the information indicating that the inquiry has not been solved is not transmitted to the external entity, the unsolved inquiry user detection module 146 may transmit the information stored on the behavioral state memory 122 and the log of inquires and replies to the external entity.

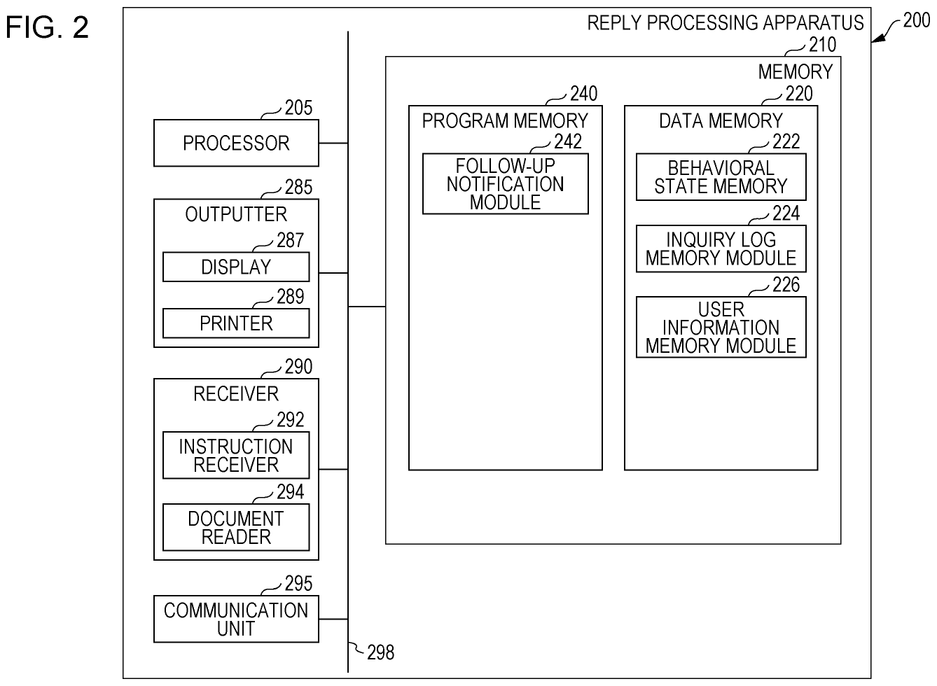

FIG. 2 illustrates a conceptual modular configuration of a structure of the exemplary embodiment.

An reply processing apparatus 200 communicates with the information processing apparatus 100. In other words, the reply processing apparatus 200 is an external entity to which the information processing apparatus 100 transmits “the information indicating that the question in the inquiry of the user has not been solved.” If a robot replies, the reply processing apparatus 200 may be the robot and an inquiry destination.

The modules in the reply processing apparatus 200 other than the modules in a data memory 220 and program memory 240 have functions similar to those of the counterparts in the information processing apparatus 100. Specifically, the modules other than a behavioral state memory 222, inquiry log memory module 224, user information memory module 226, and follow-up notification module 242 in the reply processing apparatus 200 are respectively identical in function to the modules in the information processing apparatus 100 having symbol numbers with the same lower two digits.

The data memory 220 stores the behavioral state memory 222, inquiry log memory module 224, and user information memory module 226.

The behavioral state memory 222 stores the log of the operations of the user.

The inquiry log memory module 224 stores the log of inquiries of the user.

The user information memory module 226 stores information related to the user. For example, the user information memory module 226 stores the identities of the user and a person in charge of the user in association with each other.

The program memory 240 stores the follow-up notification module 242.

When the information indicating that the question in the inquiry of the user has not been solved is received from the information processing apparatus 100, the follow-up notification module 242 creates a document by using the log of operations of the user stored on the behavioral state memory 222 and the log of inquiries of the user stored on the inquiry log memory module 224 and transmits the document to a person in charge of the user. Information related to the person in charge of the user is stored on the user information memory module 226. For example, the user information memory module 226 stores a table that associates the user with the person in charge of the user. The transmission may be performed by using an email or a message transmission and reception function of social networking service (SNS).

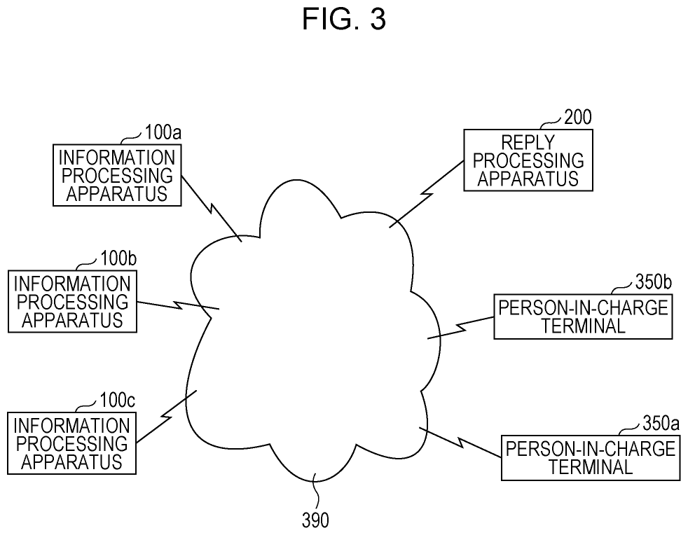

FIG. 3 illustrates an example of a system configuration of the exemplary embodiment.

The information processing apparatuses 100a, 100b, and 100c, reply processing apparatus 200, and person-in-charge terminals 350a and 350b are connected to each other via a communication network 390. The communication network 390 may be a wireless network, a wired network, or a combination thereof. For example, the communication network 390 may be the Internet or intranet as a communication infrastructure. The function of the information processing apparatus 100 or the function of the reply processing apparatus 200 may be implemented as a cloud service.

Currently available techniques include database marketing, customer relationship management (CRM), and CRM applied for contact center. The database marketing supports sales by scientifically analyzing data on a customer company stored on a computer.

The CRM of the related art takes good care of customers by using effectively customer information or improves service provision between customers and a contact center by analyzing orders from the customers and contents of inquiries and by extracting an inquiry leading to dissatisfaction and complaints.

However, the CRM of the related art is based on the condition that a customer has made complaints to the contact center and the case in which the customer has not made complaints to the contact center is not considered. The case in which the customer has not made complaints to the contact center is considered relatively rare. This is because the contact center is human (typically an expert familiar with the question in the inquiry) and a basic conversation is considered to be established.

As inquiry methods between customer and contact center are diversified, replying to inquiry is increasingly performed by robots. The replying to the inquiry is widely performed by chatbot. In some advanced cases, a robot replies to an inquiry in a contact center (phonebot). Because of labor shortage, an answerer may not necessarily be an expert or may be a person whose native language is different from that of an inquirer.

If such an inquiry method is widely used, inquiry and reply operations performed between a customer (human) and a contact center (robot) will increase in the future. In such a case, it is typically difficult to fully understand the intention of the customer (human) and the cases in which the customer ends up frustrated may possibly increase. In other words, the customer may end the conversation without successfully conveying complaints to the contact center.

In such a case, sufficient information is not extracted, a log of reactions is not extracted, and customer service is not sufficiently performed. As a result, the contact center and the sales person are unable to follow enough the inquiry.

Customer dissatisfaction is thus accumulated. Without follow-up operation by the contact center and sales person, a contract may possibly lead to cancellation.

The information processing apparatus 100 and reply processing apparatus 200 of the exemplary embodiment perform operations described below.

A user as a customer makes an inquiry to the reply processing apparatus 200 by using the information processing apparatus 100 having a softphone. After detecting an operation related to the end of the inquiry, the user may access a homepage provided by the reply processing apparatus 200. Such an operation may be typically performed when the question in the inquiry of the user is not solved. If such an operation is performed, the information processing apparatus 100 transmits to the reply processing apparatus 200 the information indicating that the question in the inquiry of the user has not been solved. The reply processing apparatus 200 creates a document by using the log of the operations of the user and the log of inquiries of the user and transmits the document to a person in charge of the user (such as the person-in-charge terminal 350a). The person in charge of the user performs a follow-up operation to reduce dissatisfaction, for example, by asking a question “Do you have any problem?”.

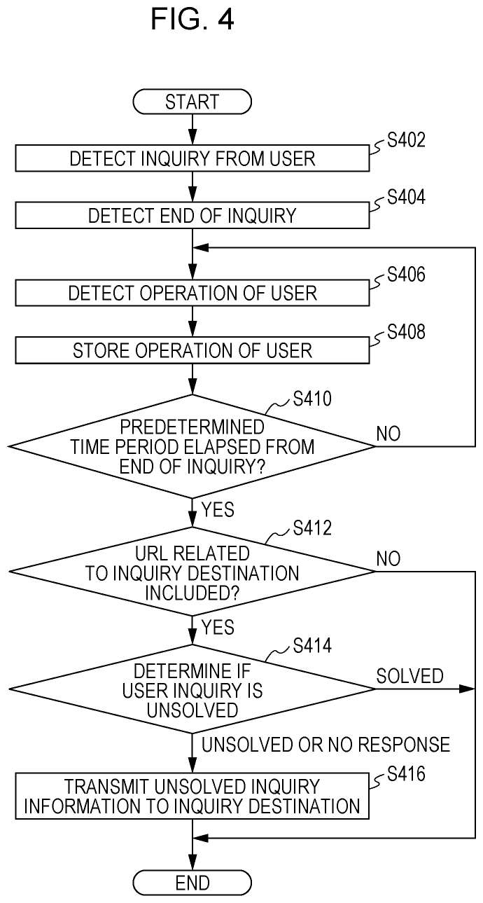

FIG. 4 is a flowchart illustrating a process example of the exemplary embodiment (the information processing apparatus 100).

In step S402, the monitoring module 144 detects an inquiry from the user.

In step S404, the monitoring module 144 detects the end of the inquiry.

In step S406, the monitoring module 144 detects an operation of the user.

In step S408, the monitoring module 144 stores the operation of the user on the behavioral state memory 122.

In step S410, the monitoring module 144 determines whether a predetermined period of time has elapsed since the end of the inquiry. If the predetermined period of time has elapsed, the process proceeds to step S412; otherwise, the process returns to step S406.

In step S412, the unsolved inquiry user detection module 146 determiners whether a uniform resource locator (URL) related to an inquiry destination is included in an operation log of the user after the end of the inquiry. If the URL is included in the operation log, the process proceeds to step S414; otherwise, the process ends.

In step S414, the unsolved inquiry user detection module 146 checks with the user to see whether the inquiry has been solved. If the user reaction is an unsolved inquiry or no reaction is detected from the user, the process proceeds to step S416. If the user reaction is a solved inquiry, the process ends.

In step S416, the unsolved inquiry user detection module 146 transmits unsolved inquiry information to an inquiry destination (the reply processing apparatus 200). The unsolved inquiry information includes the information indicating that the question in the inquiry of the user has not been solved. The unsolved inquiry information may further include an “operation log of the user after the end of the inquiry” and a “log of inquiries and replies.” Even when the information indicating that the question in the inquiry of the user has not been solved is not transmitted, the operation log of the user after the end of the inquiry and the log of inquiries and replies may be transmitted to the inquiry destination (the reply processing apparatus 200).

If the unsolved inquiry user detection module 146 determiners in step S412 that the URL related to the inquiry destination is included in the operation log of the user after the end of the inquiry, the unsolved inquiry user detection module 146 determines that the inquiry is not solved without performing the operation in step S414.

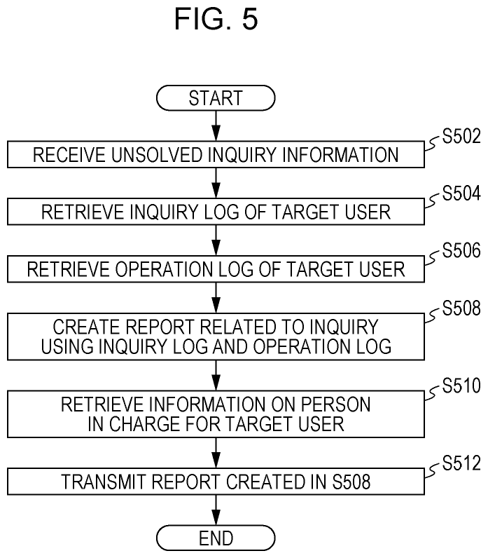

FIG. 5 is a flowchart illustrating a process example of the exemplary embodiment (the reply processing apparatus 200).

In step S502, the follow-up notification module 242 receives the unsolved inquiry information from the information processing apparatus 100.

In step S504, the follow-up notification module 242 retrieves the inquiry log of the user serving as a target from the inquiry log memory module 224.

In step S506, the follow-up notification module 242 retrieves from the behavioral state memory 222 the operation log of the user serving as the target.

In step S508, the follow-up notification module 242 creates a report related to the inquiry by using the inquiry log and the operation log.

In step S510, the follow-up notification module 242 retrieves information about the person in charge of the user serving as the target.

In step S512, the follow-up notification module 242 transmits the report created in step S508 to the person in charge.

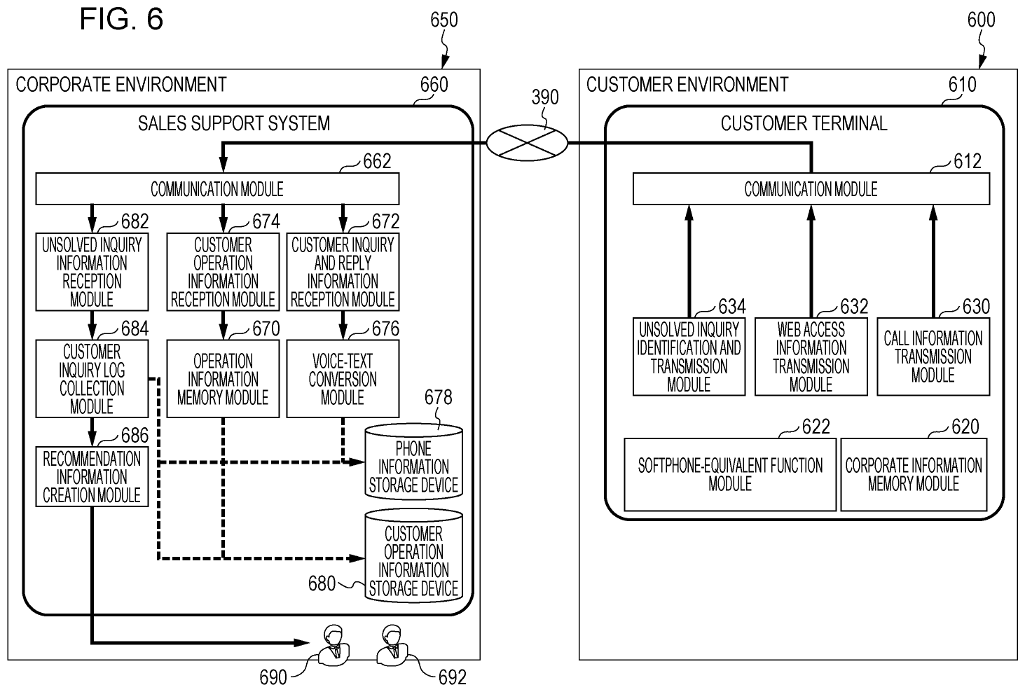

FIG. 6 illustrates a conceptual modular configuration of a customer terminal 610 and a sales support system 660 as a specific example of the exemplary embodiment. The customer terminal 610 and sales support system 660 are connected to each other for communication via a communication network 390. The customer terminal 610 is a specific example of the information processing apparatus 100 and the sales support system 660 is a specific example of the reply processing apparatus 200.

The customer terminal 610 is installed in a customer environment 600. Multi-function apparatuses are also installed in the customer environment 600. A user makes an inquiry by using the customer terminal 610.

The customer terminal 610 includes a communication module 612, corporate information memory module 620, softphone-equivalent function module 622, call information transmission module 630, web access information transmission module 632, and unsolved inquiry identification and transmission module 634. For example, the customer terminal 610 may be a personal computer or a portable information communication terminal.

The communication module 612 is connected to the call information transmission module 630, web access information transmission module 632, and unsolved inquiry identification and transmission module 634 and is also connected to the communication module 662 in the sales support system 660 in the corporate environment 650 via the communication network 390. The communication module 612 communicates with the communication module 662.

The corporate information memory module 620 communicates with the sales support system 660 and stores a domain or the like of the sales support system 660.

The softphone-equivalent function module 622 has a softphone-equivalent function and communicates with the user of the customer terminal 610 and the sales support system 660.

The call information transmission module 630 is connected to the communication module 612. The call information transmission module 630 performs the following operations.

(1) The call information transmission module 630 records a call start time responsive to the start of the call of the softphone-equivalent function module 622 and transmits the call start time to the sales support system 660.

(2) The call information transmission module 630 records a call end time responsive to the end of the call of the softphone-equivalent function module 622 and transmits the call end time to the sales support system 660.

(3) The call information transmission module 630 records a software identification (ID) responsive to the start of the call of the softphone-equivalent function module 622 and transmits the software ID to the sales support system 660.

The web access information transmission module 632 is connected to the communication module 612. The web access information transmission module 632 performs the following operations.

(1) The web access information transmission module 632 records an access log to a web (specifically, an access destination URL or the like) responsive to the start of the call of the softphone-equivalent function module 622 and transmits the access log to the sales support system 660.

(2) The web access information transmission module 632 records a web access time responsive to the start of the call of the softphone-equivalent function module 622 and transmits the web access time to the sales support system 660.

(3) The web access information transmission module 632 records a software ID responsive to the start of the call of the softphone-equivalent function module 622 and transmits the software ID to the sales support system 660.

The unsolved inquiry identification and transmission module 634 is connected to the communication module 612. The unsolved inquiry identification and transmission module 634 performs the following operations.

(1) The unsolved inquiry identification and transmission module 634 references the access log to the web and the domain of the sales support system 660 and determines whether the user has an unsolved question in the inquiry. Specifically, if the domain of the sales support system 660 is included in the access log to the web after the end of the call of the softphone-equivalent function module 622, the unsolved inquiry identification and transmission module 634 determines that the user has the unsolved question in the inquiry.

(2) The unsolved inquiry identification and transmission module 634 checks via a popup display with the user determined as having the unsolved question in the inquiry whether the question is solved.

(3) The unsolved inquiry identification and transmission module 634 transmits to the sales support system 660 the information indicating that the question in the inquiry of the user has not been solved.

The sales support system 660 is deployed in the corporate environment 650 and includes a sales person 690 and a contact center 692.

The sales support system 660 includes a communication module 662, operation information memory module 670, customer inquiry and reply information reception module 672, customer operation information reception module 674, voice-text conversion module 676, phone information storage device 678, customer operation information storage device 680, unsolved inquiry information reception module 682, customer inquiry log collection module 684, and recommendation information creation module 686.

The communication module 662 is connected to the customer inquiry and reply information reception module 672, customer operation information reception module 674, and unsolved inquiry information reception module 682. The communication module 662 is also connected to the communication module 612 in the customer terminal 610 in the customer environment 600 via the communication network 390. The communication module 662 communicates with the communication module 612.

The customer inquiry and reply information reception module 672 is connected to the communication module 662 and the voice-text conversion module 676. The customer inquiry and reply information reception module 672 talks with the user of the customer terminal 610. Specifically, the customer inquiry and reply information reception module 672 receives a user voice inquiry from the customer terminal 610 and transmits voice reply responsive to the voice inquiry to the customer terminal 610. The customer inquiry and reply information reception module 672 has the function of interactive voice response (IVR).

The voice-text conversion module 676 is connected to the customer inquiry and reply information reception module 672 and phone information storage device 678. The voice-text conversion module 676 recognizes the voice from the customer terminal 610 and causes the phone information storage device 678 to store the recognition results and text information on a reply.

The phone information storage device 678 is connected to the voice-text conversion module 676 and customer inquiry log collection module 684. The phone information storage device 678 stores the voice recognition results and the text information on the reply, namely, a reply log from the customer terminal 610.

The customer operation information reception module 674 is connected to the communication module 662 and operation information memory module 670. The customer operation information reception module 674 receives the operation log transmitted from the customer terminal 610.

The operation information memory module 670 is connected to the customer operation information reception module 674 and customer operation information storage device 680. The operation information memory module 670 causes the customer operation information storage device 680 to store the operation log received by the customer operation information reception module 674.

The customer operation information storage device 680 is connected to the operation information memory module 670 and customer inquiry log collection module 684. The customer operation information storage device 680 stores the operation log of the user as a customer.

The unsolved inquiry information reception module 682 is connected to the communication module 662 and customer inquiry log collection module 684. The unsolved inquiry information reception module 682 receives “the information indicating the user having an unsolved question in the inquiry” transmitted from the customer terminal 610.

The customer inquiry log collection module 684 is connected to the phone information storage device 678, customer operation information storage device 680, unsolved inquiry information reception module 682, and recommendation information creation module 686. The customer inquiry log collection module 684 collects the log of replies responsive to the user inquiry and the operation log from the phone information storage device 678 and the customer operation information storage device 680.

The recommendation information creation module 686 is connected to the customer inquiry log collection module 684, sales person 690, and contact center 692. The recommendation information creation module 686 creates a report by using the log of the replies and the operation log and transmits the report to the person in charge of the user (the sales person 690 or the contact center 692).

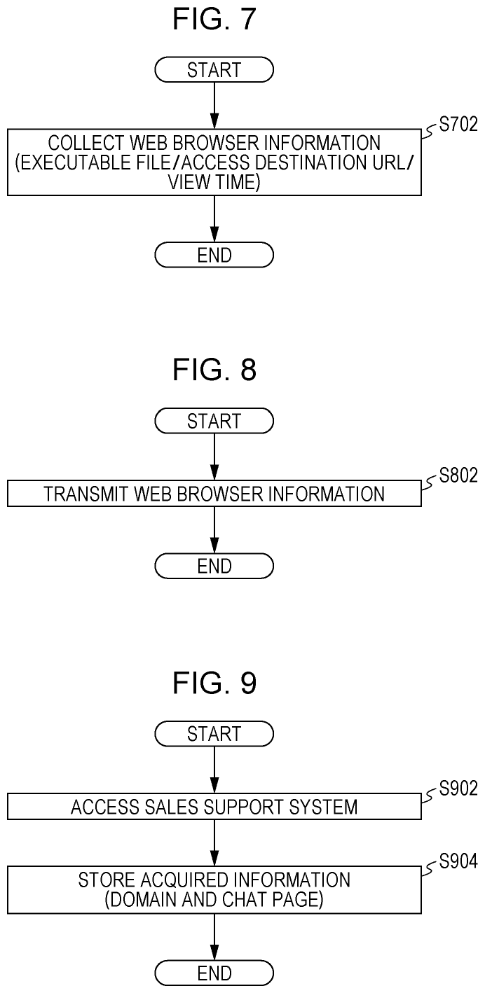

Flowcharts in FIGS. 7 through 11 illustrate process examples of the customer terminal 610.

FIG. 7 is a flowchart illustrating the process example of the exemplary embodiment (the web access information transmission module 632).

In step S702, web browser information of an operation of a user of the customer terminal 610 (executable file, access destination URL, view time) is collected. For example, the web access information transmission module 632 as a monitoring process resides and operates on a real-time basis.

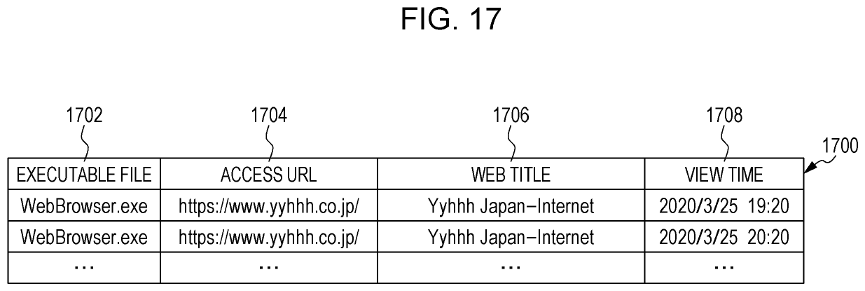

A web access information table 1700 is created as collection results obtained in step S702. FIG. 17 illustrates a data structure of the web access information table 1700. The web access information table 1700 includes an executable file column 1702, access URL column 1704, web title column 1706, and view time column 1708. The executable file column 1702 stores an executable file. The access URL column 1704 stores an access URL. The web title column 1706 stores a web title. The view time column 1708 stores view time.

Software provided by a company manufacturing the sales support system 660 has a function of causing a process to reside. If a web browser is accessed by using the customer terminal 610, the software accumulates information related to the web browser like the web access information table 1700 in FIG. 17.

For example, the first row of the web access information table 1700 indicates that an executable file “WebBrowser.exe” has an access URL https://www.yyhhh.co.jp/, a web title “Yyhhh Japan-Internet,” and view time “2020/3/25 19:20.” The second row of the web access information table 1700 indicates that an executable file “WebBrowser.exe” has an access URL https://www.yyhhh.co.jp/, a web title “Yyhhh Japan-Internet,” and view time “2020/3/25 20:20.”

FIG. 8 is a flowchart illustrating a process example of the exemplary embodiment (the communication module 612).

In step S802, the web access information transmission module 632 transmits collected web browser information to the sales support system 660.

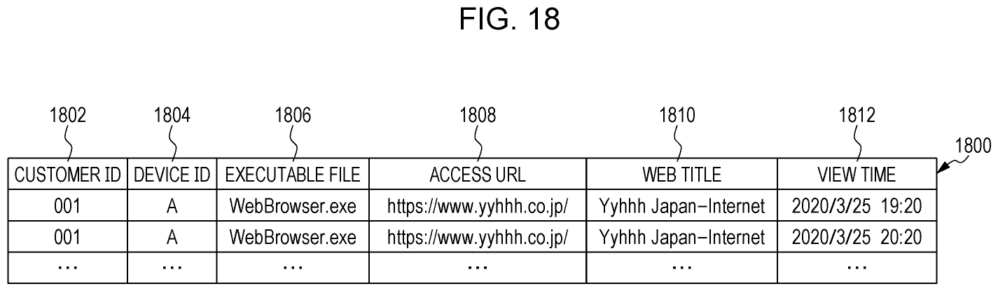

The data transmitted in step S802 may be a transmission web access information table 1800. Web access information collection results collected in step S702 are periodically transmitted to the sales support system 660. When the web access information collection results are transmitted, user information is attached thereto. FIG. 18 illustrates a data structure of the transmission web access information table 1800. The transmission web access information table 1800 includes a customer ID column 1802, device ID column 1804, executable file column 1806, access URL column 1808, web title column 1810, and view time column 1812. The customer ID column 1802 stores information uniquely identifying a customer (specifically, a customer ID) in the exemplary embodiment. The device ID column 1804 stores information uniquely identifying a device (specifically, a device ID) in the exemplary embodiment. The executable file column 1806 stores an executable file. The access URL column 1808 stores an access URL. The web title column 1810 stores a web title. The view time column 1812 stores view time.

For example, the first row of the transmission web access information table 1800 indicates that a customer ID 001 has a device ID “A,” an executable file “WebBrowser.exe,” an access URL https://www.yyhhh.co.jp/, a web title “Yyhhh Japan-Internet,” and view time “2020/3/25 19:20.” The second row of the transmission web access information table 1800 indicates that a customer ID 001 has a device ID “A,” an executable file “WebBrowser.exe,” an access URL https://www.yyhhh.co.jp/, a web title “Yyhhh Japan-Internet,” and view time “2020/3/25 20:20.”

FIG. 9 is a flowchart illustrating a process example of the exemplary embodiment (the corporate information memory module 620).

In step S902, the corporate information memory module 620 accesses the sales support system 660.

In step S904, the corporate information memory module 620 stores acquired information (domain, chat page, and the like).

The corporate information memory module 620 repeats operations in steps S902 and S904 every specific time period (for example, every hours).

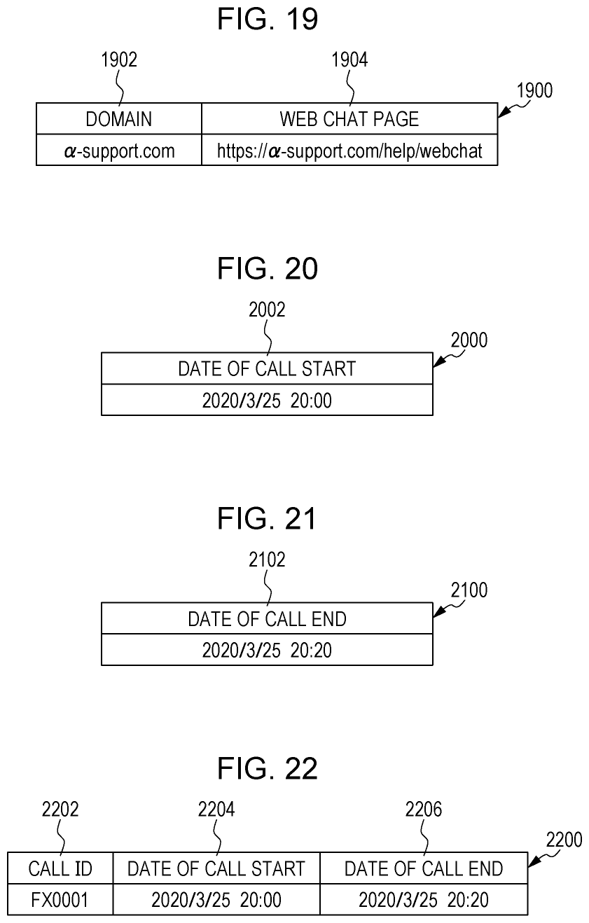

The data stored in step S904 is, for example, a corporate information table 1900. FIG. 19 illustrates a data structure of the corporate information table 1900. The corporate information table 1900 includes a domain column 1902 and web chat page column 1904. The domain column 1902 stores a domain. The web chat page column 1904 stores a web chat page.

The first row of the corporate information table 1900 indicates that a domain “α-support.com” has a web chat page “https://α-support.com/help/webchat.”

Agent software accesses the sales support system 660 and acquires corporate information related to the α company. In this case, the domain of the α company and a page URL at a web chat are acquired. Operations in steps S902 and S904 are periodically repeated to update the corporate information table 1900 to the latest information.

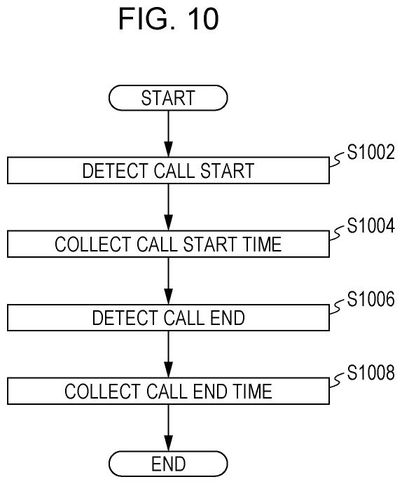

FIG. 10 is a flowchart illustrating a process example of the exemplary embodiment (the softphone-equivalent function module 622 and the call information transmission module 630).

In step S1002, the call start between the user and the sales support system 660 is detected.

The agent software monitors the softphone-equivalent function module 622 and the process in the flowchart in FIG. 10 is triggered in response to the start of the call. For example, the agent software captures a signal selecting a call button on the softphone-equivalent function module 622 and starts a subsequent process.

In step S1004, the call start time is collected. The agent software records the date of the call start like the date of call start table 2000. FIG. 20 illustrates a data structure of the date of call start table 2000. The date of call start table 2000 includes a date of call start column 2002. The date of call start table 2000 stores the date of call start. Referring to FIG. 20, the date of call start is “2020/3/25 20:00.”

In step S1006, the end of call between the user and the sales support system 660 is detected. In a way similar to step S1002, the agent software detects the end of the call.

In step S1008, the time of the call end is detected. The agent software stores the date of the call end as a date of call end table 2100. FIG. 21 illustrates a data structure of the date of call end table 2100. The date of call end table 2100 includes a date of call end column 2102. The date of call end column 2102 stores the date of the call end. Referring to FIG. 21, the date of the call end is “2020/3/25 20:20.”

A transmission call information table 2200 is created. The date of call start table 2000 may be transmitted to the sales support system 660. FIG. 22 illustrates a data structure of the transmission call information table 2200. The transmission call information table 2200 includes a call ID column 2202, date of call start column 2204, and date of call end column 2206. In accordance with the exemplary embodiment, the call ID column 2202 stores information uniquely identifying a call (specifically, a call ID). The date of call start column 2204 stores the date of the call start. The date of call end column 2206 stores the date of the call end.

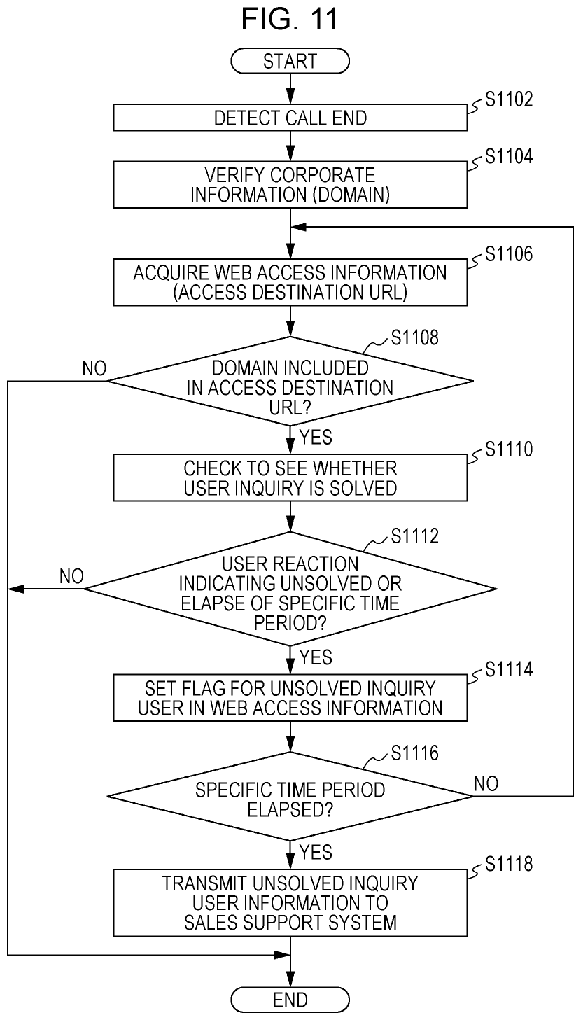

FIG. 11 is a flowchart illustrating a process example of the exemplary embodiment (the unsolved inquiry identification and transmission module 634).

In step S1102, the end of the call is detected.

In step S1104, corporate information (such as a domain) of the sales support system 660 of the inquiry destination is verified in accordance with the corporate information memory module 620 by using the corporate information memory module 620. For example, upon detecting the end of the call, the agent software acquires the domain stored in step S904. In the preceding case (FIG. 19), “α-support.com” is acquired.

In step S1106, web access information (access destination URL) is acquired by using the web access information transmission module 632. For example, the agent software accesses the access destination URL of the information collected in step S702.

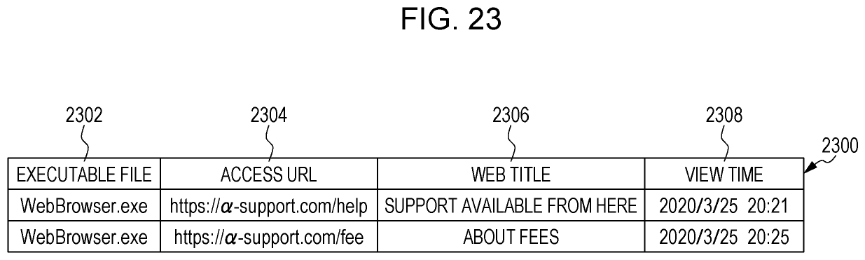

In step S1108, the unsolved inquiry identification and transmission module 634 determines whether the domain is included in the access destination URL. If the domain is included in the access destination URL, the process proceeds to step S1110; otherwise, the process ends. Specifically, the unsolved inquiry identification and transmission module 634 compares the domain information acquired in step S1104 with the information acquired in step S1106 to determine whether the domain is included in the access destination URL. If the domain is included in the access destination URL, the yes path is followed. If the domain is not included in the access destination URL, the no path is followed. Since the domain information (α-support.com) is included in the access destination URL in FIG. 23, the yes path is followed (with an unsolved inquiry). FIG. 23 illustrates a data structure of a web access information table 2300. The web access information table 2300 is identical to the web access information table 1700 in FIG. 17. The web access information table 2300 includes an executable file column 2302, access URL column 2304, web title column 2306, and view time column 2308.

The executable file column 2302 stores an executable file. The access URL column 2304 stores an access URL. The web title column 2306 stores a web title. The view time column 2308 stores view time. The first row of the web access information table 2300 indicates that an executable file “WebBrowser.exe” has an access URL “https://α-support.com/help”, a web title “Support available from here,” and view time “2020/3/25 20:21.” The second row of the web access information table 2300 indicates that an executable file “WebBrowser.exe” has an access URL “https://α-support.com/fee”, a web title “About fees,” and view time “2020/3/25 20:25.”

An unsolved inquiry user is described below. In this example, the user accesses the system immediately subsequent to the end of the call because the user may possibly have a question and try to find out information on a service providing company. Specifically, the user is determined as an unsolved inquiry user because the data at the first and second rows in the view time column 2308 indicates that the view time is within a predetermined period of time (for example, 15 minutes) after the date of the end of the call and “α-support” is included in the access URL column 2304.

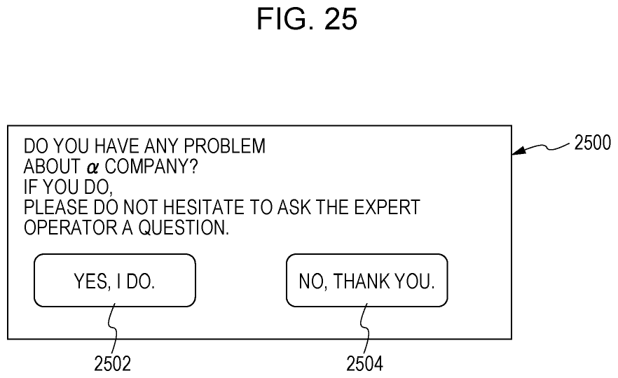

In step S1110, the unsolved inquiry identification and transmission module 634 checks with the user to see whether the question in the inquiry has solved or not. In order to increase the accuracy of the unsolved inquiry in response to the information acquired in step S1108, the agent software popup-displays a verification screen 2500 for user confirmation. FIG. 25 illustrates a display example of the verification screen 2500. The verification screen 2500 displays a comment reading “Do you have any problem about α company? If you do, please do not hesitate to ask the expert operator a question” and then displays a “Yes, I do” button 2502 and a “No, thank you” button 2504.

The unsolved inquiry identification and transmission module 634 determines in step S1112 whether the user reaction indicates unsolved or the elapse of a specific time period. If the user reaction indicates unsolved or the elapse of the specific time period, the process proceeds to step S1114; otherwise (the user reaction indicates solved), the process ends.

In the preceding example, the user confirms the verification screen 2500. After confirming the verification screen 2500, the user selects between the “Yes, I do” button 2502 and the “No, thank you” button 2504. If the “Yes, I do” button 2502 is selected, the process proceeds to the following steps (step S1114 and subsequent steps).

The user may possibly avoid yes/no answer (selecting neither the “Yes, I do” button 2502 nor the “No, thank you” button 2504). After the elapse of the predetermined time period, the following operations (steps S1114 and thereafter) are performed. Specifically, if there is no user reaction, the inquiry is determined to be not solved. Only if the user selects the “No, thank you” button 2504, the following operations (steps S1114 and thereafter) are not performed.

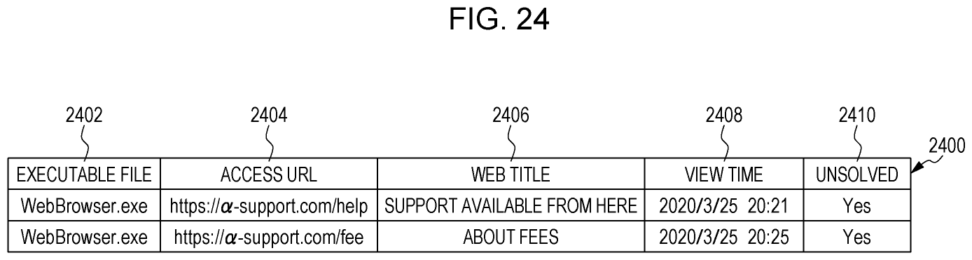

In step S1114, the unsolved inquiry identification and transmission module 634 sets a flag for an unsolved inquiry user in the web access information. Specifically, the flag is set if the yes path is followed in step S1108. For example, the flag is set in an unsolved inquiry user web access information table 2400. FIG. 24 illustrates a data structure of the unsolved inquiry user web access information table 2400. The unsolved inquiry user web access information table 2400 is created by adding the unsolved column 2410 to the web access information table 2300. The unsolved inquiry user web access information table 2400 includes an executable file column 2402, access URL column 2404, web title column 2406, view time column 2408, and unsolved column 2410.

The executable file column 2402 stores an executable file. The access URL column 2404 stores an access URL. The web title column 2406 stores a web title. The view time column 2408 stores view time. The unsolved column 2410 stores information as to whether the inquiry is solved or not.

The first row of the unsolved inquiry user web access information table 2400 indicates that an executable file “WebBrowser.exe” has an access URL “https://α-support.com/help”, a web title “Support available from here,” view time “2020/3/25 20:21,” and a flag “unsolved.” The second row of the unsolved inquiry user web access information table 2400 indicates that an executable file “WebBrowser.exe” has an access URL “https://α-support.com/fee,” a web title “About fees,” view time “2020/3/25 20:25,” and a flag “unsolved.”

The unsolved inquiry identification and transmission module 634 determines in step S1116 whether a specific period of time has elapsed. If the specific period of time has elapsed, the process proceeds to step S1118; otherwise, the process returns to step S1106. The specific period of time in step S1116 is different from the specific period of time in step S1112 and indicates a time period through which the agent software collects information about unsolved inquiry users.

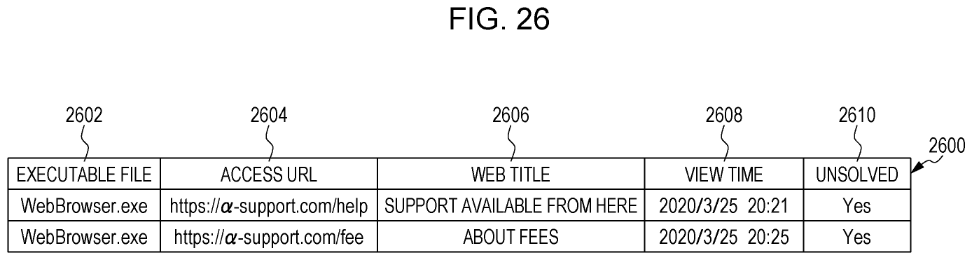

In step S1118, the unsolved inquiry user information is transmitted to the sales support system 660. The agent software verifies the flag determined in step S1110. If the flag is set (yes), the agent software creates user information and transmits the user information to the sales support system 660. Web access information is transmitted as the determination results together with the user information. For example, an unsolved inquiry user web access information table 2600 and an unsolved inquiry user list table 2700 are transmitted. FIG. 26 illustrates a data structure of the unsolved inquiry user web access information table 2600.

The unsolved inquiry user web access information table 2600 includes an executable file column 2602, access URL column 2604, web title column 2606, view time column 2608, and unsolved column 2610. The executable file column 2602 stores an executable file. The access URL column 2604 stores an access URL. The web title column 2606 stores a web title. The view time column 2608 stores view time. The unsolved column 2610 stores information as to whether the inquiry is solved or not.

The first row of the unsolved inquiry user web access information table 2600 indicates that an executable file “WebBrowser.exe” has an access URL “https://α-support.com/help”, a web title “Support available from here,” view time “2020/3/25 20:21,” and a flag “unsolved.” The second row of the unsolved inquiry user web access information table 2600 indicates that an executable file “WebBrowser.exe” has an access URL “https://α-support.com/fee,” a web title “About fees,” view time “2020/3/25 20:25,” and a flag “unsolved.”

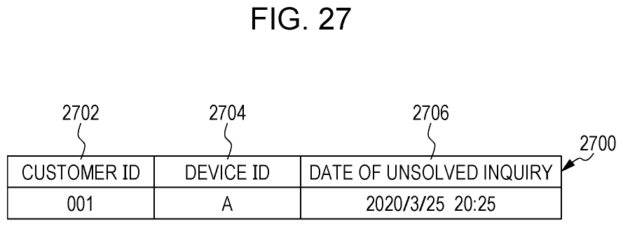

FIG. 27 illustrates a data structure of the unsolved inquiry user list table 2700. The unsolved inquiry user list table 2700 includes a customer ID column 2702, device ID column 2704, and date of unsolved inquiry column 2706. The customer ID column 2702 stores a customer ID. The device ID column 2704 stores a device ID. The date of unsolved inquiry column 2706 stores the date of the unsolved inquiry. The first row of the unsolved inquiry user list table 2700 indicates that a customer ID 001 has a device ID “A,” and the date of the unsolved inquiry “2020/3/25 20:25.”

The operations in steps S1110, S1112, and S1116 may be omitted. In other words, if the yes path is followed in step S1108, the process may proceed to steps S1114 and S1118.

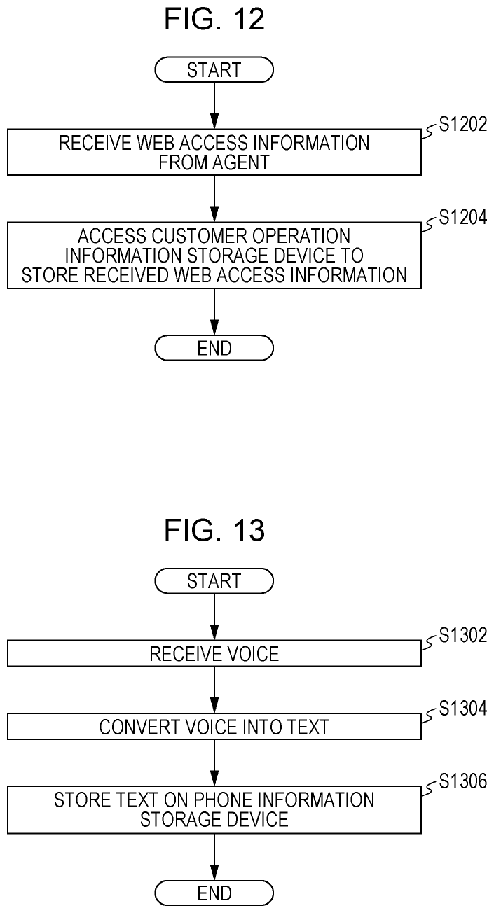

FIGS. 12 through 16 are flowcharts of the processes performed by the sales support system 660.

FIG. 12 illustrates a process example of the exemplary embodiment.

In step S1202, the sales support system 660 receives the web access information from the agent software of the customer terminal 610. Specifically, the sales support system 660 receives the unsolved inquiry user web access information table 2600 and the unsolved inquiry user list table 2700.

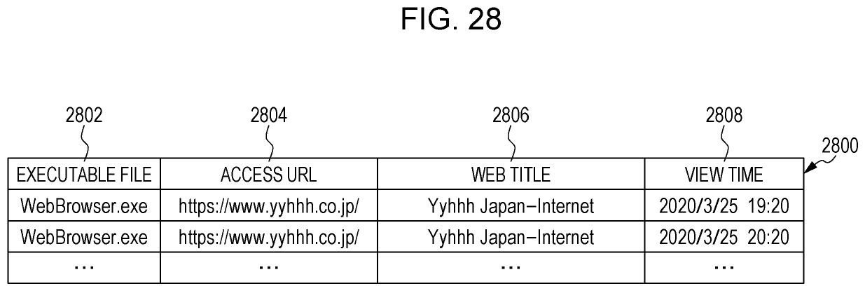

In step S1204, the sales support system 660 accesses the customer operation information storage device 680 store the received web access information on the customer operation information storage device 680. Specifically, the sales support system 660 receives the web access information table 1700 accumulated in step S702 and registers the web access information table 1700 as a database on the customer operation information storage device 680. For example, a web access information table 2800 is stored. FIG. 28 illustrates a data structure of the web access information table 2800. The web access information table 2800 includes an executable file column 2802, access URL column 2804, web title column 2806, and view time column 2808.

The executable file column 2802 stores an executable file. The access URL column 2804 stores an access URL. The web title column 2806 stores a web title. The view time column 2808 stores view time.

The first row of the web access information table 2800 indicates that an executable file “WebBrowser.exe” has an access URL https://www.yyhhh.co.jp/, a web title “Yyhhh Japan-Internet,” and view time “2020/3/25 19:20.” The second row of the web access information table 2800 indicates that an executable file “WebBrowser.exe” has an access URL https://www.yyhhh.co.jp/, a web title “Yyhhh Japan-Internet,” and view time “2020/3/25 20:20.”

FIG. 13 is a flowchart illustrating a process example of the exemplary embodiment.

In step S1302, the sales support system 660 receives a user voice inquiry from the customer terminal 610.

In step S1304, the sales support system 660 converts the voice into text. As described above, the voice is converted into text through interactive voice response (IVR).

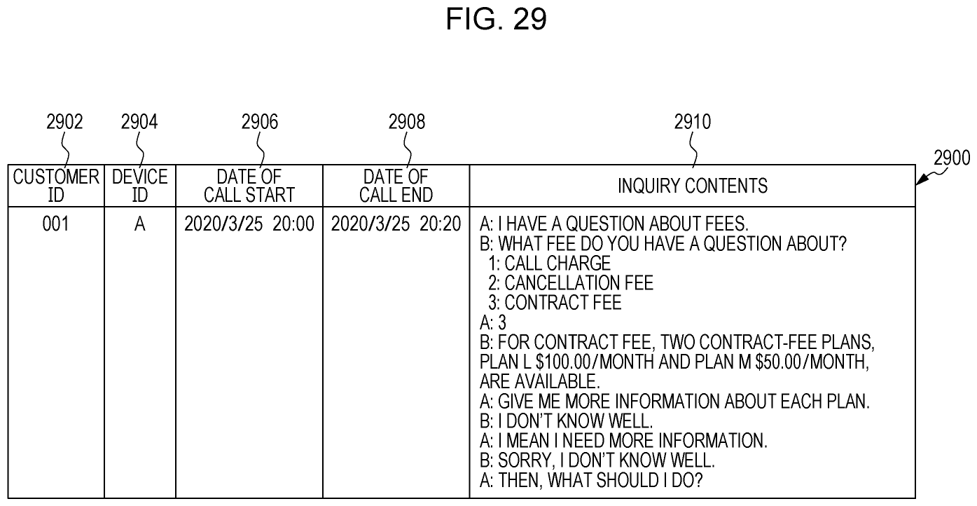

In step S1306, the sales support system 660 stores the text (specifically, the text converted in step S1304 or the text in reply to the inquiry) on the phone information storage device 678. Information on phone response is accumulated and registered together with inquiry contents created in step S1304 on the phone information storage device 678 serving as a database in a phone information table 2900. FIG. 29 illustrates a data structure of the phone information table 2900. The phone information table 2900 includes a customer ID column 2902, device ID column 2904, date of call start column 2906, date of call end column 2908, and inquiry contents column 2910. The customer ID column 2902 stores a customer ID. The device ID column 2904 stores a device ID. The date of call start column 2906 stores the date of the call start. The date of call end column 2908 stores the date of the call end. The inquiry contents column 2910 stores the contents of the inquiry.

The first row of the phone information table 2900 indicates, for example, that a customer ID 001 has a device ID “A,” the date of the call start “2020/3/25 20:00,” the date of the call end “2020/3/25 20:20, and the following inquiry contents. Note that the customer ID “A” is the user of the customer terminal 610 and the customer ID “B” is a robot.

A: I have a question about fees.
B: What fee do you have a question about?.

1. Call charge

2. Cancellation fee

3. Contract fee

### A: 3

B: For contract fee, two contract-fee plans, plan L $100.00/month and plan M $50.00/month, are available.
A: Give me more information about each plan.
B: I don't know well.
A: I mean I need more information.
B: Sorry, I don't know well.
A: Then, what should I do?

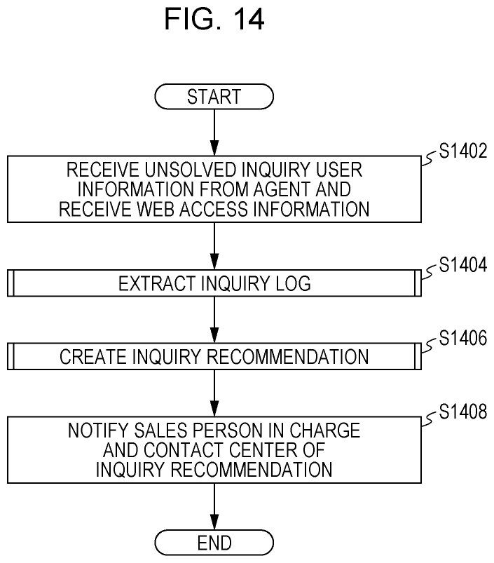

FIG. 14 is a flowchart illustrating a process example of the exemplary embodiment.

In step S1402, the sales support system 660 receives the unsolved inquiry user information transmitted from the agent software. The sales support system 660 further receives the web access information.

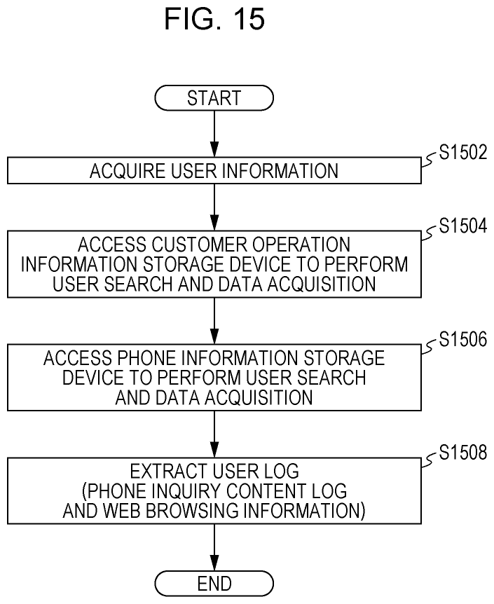

In step S1404, the sales support system 660 extracts the log of the inquiries of the user. In accordance with the information on the unsolved inquiry user, the sales support system 660 searches the customer operation information storage device 680 for the web access information and the phone information storage device 678 for the phone information. The detail of the operation in step S1404 is described below with reference to a flowchart in FIG. 15.

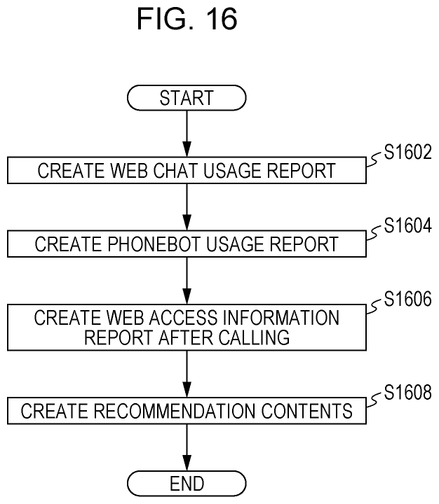

In step S1406, the sales support system 660 creates an inquiry recommendation. The sales support system 660 summarizes the web access information, the phone information and the web access information when the inquiry of the user is determined to be unsolved, thereby making a summary of an inquiry status. The detail of the operation in step S1406 is described with reference to a flowchart in FIG. 16.

In step S1408, the sales support system 660 notifies the sales person 690 in charge of the user and the contact center 692 of the inquiry recommendation. Using the summary results, the sales person 690 or the like contacts the user whose question remains unsolved, through phone, fact-to-face (F to F) video conference to follow up the user.

FIG. 15 is a flowchart illustrating a process example of the exemplary embodiment.

In step S1502, the sales support system 660 acquires user information. Namely, the sales support system 660 acquires the customer ID of the unsolved inquiry user, device ID, and occurrence time.

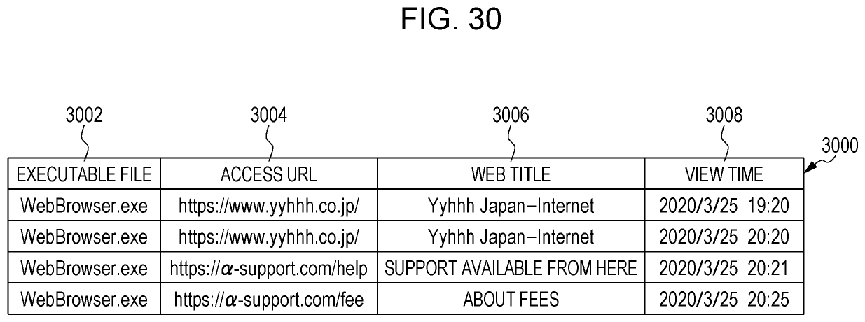

In step S1504, the sales support system 660 accesses the customer operation information storage device 680 to search for the user and to acquire data on the operation log of the user. The sales support system 660 acquires the user ID and the web access information on the user related to the device ID. For example, the sales support system 660 acquires a web access information table 3000. FIG. 30 illustrates a data structure of the web access information table 3000. The web access information table 3000 includes an executable file column 3002, access URL column 3004, web title column 3006, and view time column 3008.

The executable file column 3002 stores an executable file. The access URL column 3004 stores an access URL. the web title column 3006 stores a web title. The view time column 3008 stores view time.

The first row of the web access information table 3000 indicates that an executable file “WebBrowser.exe” has an access URL “https://www.yyhhh.co.jp/,” a web title “Yyhhh Japan-Internet,” and view time “2020/3/25 19:20.” The second row of the web access information table 3000 indicates that an executable file “WebBrowser.exe” has an access URL “https://www.yyhhh.co.jp/,” a web title “Yyhhh Japan-Internet,” and view time “2020/3/25 20:20.” The third row of the web access information table 3000 indicates that an executable file “WebBrowser.exe” has an access URL “https://α-support.com/help,” a web title “Support available from here,” and view time “2020/3/25 20:21.” The fourth row of the web access information table 3000 indicates that an executable file “WebBrowser.exe” has an access URL “https://α-support.com/fee,” a web title “About fees,” and view time “2020/3/25 20:25.”

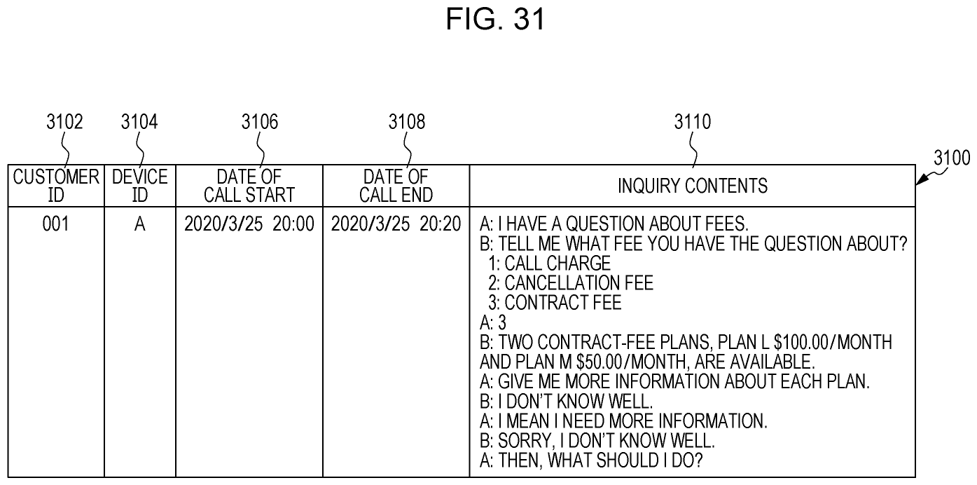

In step S1506, the sales support system 660 accesses the phone information storage device 678 to search for the user and to acquire data on an inquiry and reply. The sales support system 660 acquires from the phone information storage device 678 the user ID and phone information on the user related to the device ID. For example, the sales support system 660 acquires a phone information table 3100. FIG. 31 illustrates a data structure of the phone information table 3100. The phone information table 3100 includes a customer ID column 3102, device ID column 3104, date of call start column 3106, date of call end column 3108, and inquiry contents column 3110.

The customer ID column 3102 stores a customer ID. The device ID column 3104 stores a device ID. The date of call start column 3106 stores the date of the call start. The date of call end column 3108 stores the date of the call end. The inquiry contents column 3110 stores the contents of an inquiry. The phone information table 3100 is identical to the phone information table 2900 in FIG. 29.

In step S1508, the sales support system 660 extracts the log of the user (the log of phone inquiry contents and web browsing information).

FIG. 16 is a flowchart illustrating a process example of the exemplary embodiment.

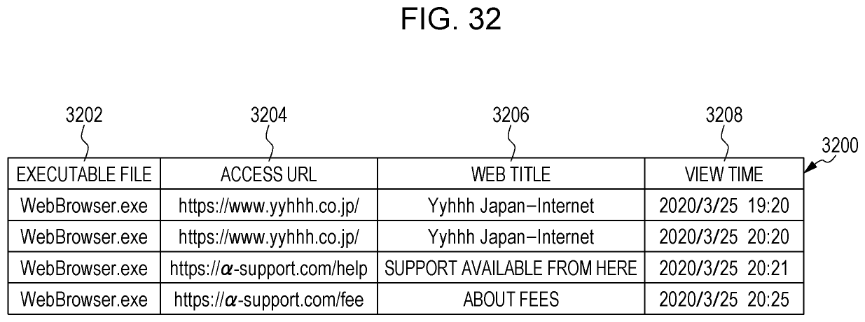

In step S1602, the sales support system 660 creates a web chat use report. The sales support system 660 determines whether the user has used chat by referencing the web access information and the URL of the web chat page. Specifically, the sales support system 660 performs this determination by using a web access information table 3200 and a corporate information table 3300. FIG. 32 illustrates a data structure of the web access information table 3200. The web access information table 3200 includes an executable file column 3202, access URL column 3204, web title column 3206, and view time column 3208.

The executable file column 3202 stores an executable file. The access URL column 3204 stores an access URL. The web title column 3206 a web title. The view time column 3208 stores view time.

The first row of the web access information table 3200 indicates that an executable file “WebBrowser.exe” has an access URL “https://www.yyhhh.co.jp/,” a web title “Yyhhh Japan-Internet,” and view time “2020/3/25 19:20.” The second row of the web access information table 3200 indicates that an executable file “WebBrowser.exe” has an access URL “https://www.yyhhh.co.jp/,” a web title “Yyhhh Japan-Internet,” and view time “2020/3/25 20:20.” The third row of the web access information table 3200 indicates that an executable file “WebBrowser.exe” has an access URL “https://α-support.com/help,” a web title “Support available from here,” and view time “2020/3/25 20:21.” The fourth row of the web access information table 3200 indicates that an executable file “WebBrowser.exe” has an access URL “https://α-support.com/fee,” a web title “About fees,” and view time “2020/3/25 20:25.”

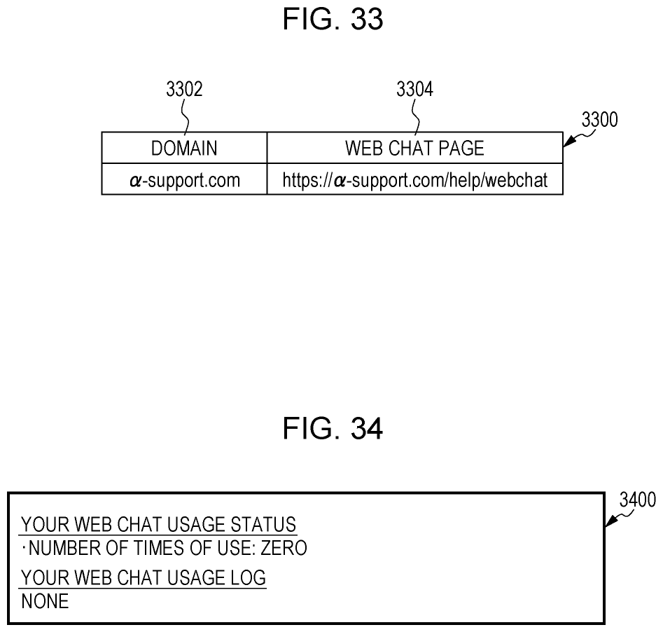

FIG. 33 illustrates a data structure of the corporate information table 3300. The corporate information table 3300 includes a domain column 3302 and web chat page column 3304. The domain column 3302 stores a domain. The web chat page column 3304 stores a web chat page. The first row of the corporate information table 3300 indicates that a domain “α-support.com” has a web chat page “https://α-support.com/help//webchat.”

The sales support system 660 determines whether the contents “https://α-support.com/help//webchat” in the web chat page column 3304 of the corporate information table 3300 are included in the access URL column 3204 in the web access information table 3200. In this case, the contents “https://α-support.com/help//webchat” are not included in the access URL column 3204. The sales support system 660 thus creates a web chat usage report 3400. FIG. 34 illustrates an example of the web chat usage report 3400 created in accordance with the exemplary embodiment. The web chat usage report 3400 includes, for example, “Your web chat status, Number of times of use: zero, Your web chat usage log: None.”

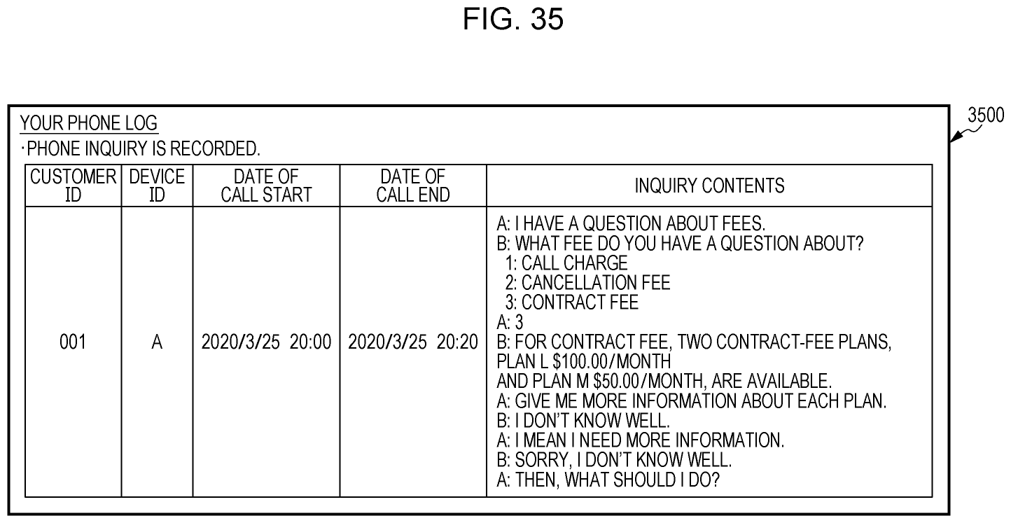

In step S1604, a phonebot usage report is created. The sales support system 660 retrieves from the phone information storage device 678 the user ID and phone information on the user related to the device ID and checks for the usage and the number of use. In this case, the user has used a phonebot once. For example, a phonebot usage report 3500 is created. FIG. 35 illustrates an example of the phonebot usage report 3500 created in accordance with the exemplary embodiment. The phonebot usage report 3500 has a record reading “Your phone log: Phone inquiry is recorded” and further includes a table identical to the phone information table 3100 in FIG. 31.

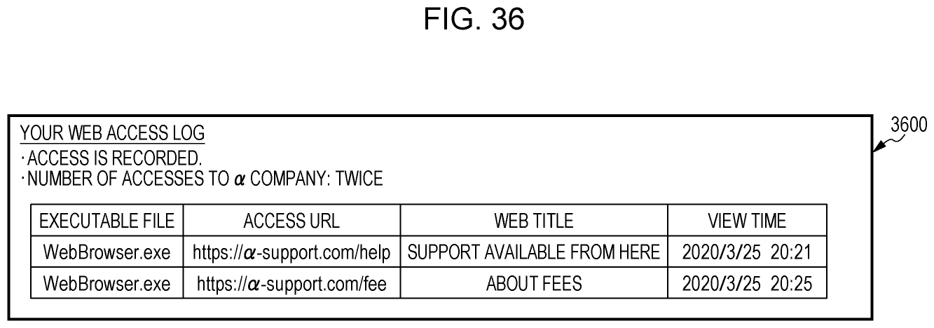

In step S1606, a web access information report subsequent the phone inquiry is created. In this example, the user has used the service twice. For example, a web access report 3600 subsequent to the phone is created. FIG. 36 illustrates an example of the web access report 3600 after the phone created in accordance with the exemplary embodiment. The web access report 3600 has a record reading “Your web access log: Access is recorded, Number of accesses to a company: twice” and includes a table identical to the web access information table 2300 in FIG. 23 (or web information accessed after the phone inquiry in the web access information table 3000 in FIG. 30).

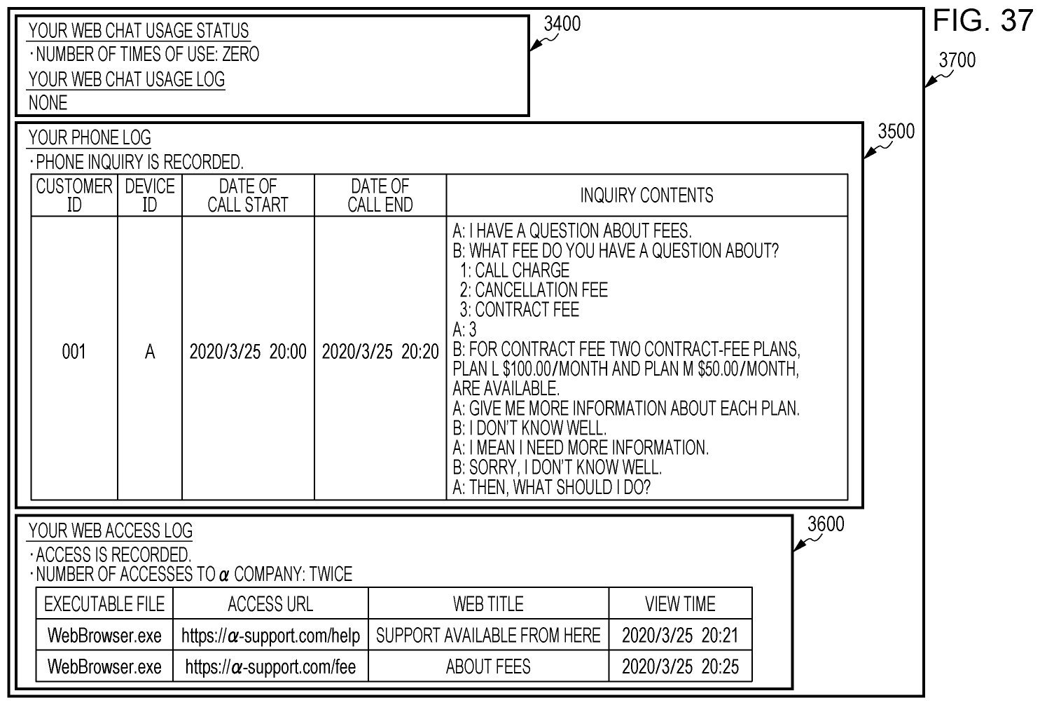

In step S1608, recommendation contents are created. Recommendation information is created in accordance with the information in steps S1602 through S1606. Slide material is created by using document creation software and is then transmitted to the sales person 690 in charge of the user and the contact center 692. For example, a report 3700 is created. FIG. 37 illustrates an example of the report 3700 created in accordance with the exemplary embodiment. The report 3700 includes a record of a combination of the web chat usage report 3400 in FIG. 34, the phonebot usage report 3500 in FIG. 35, and the web access report 3600 in FIG. 36.

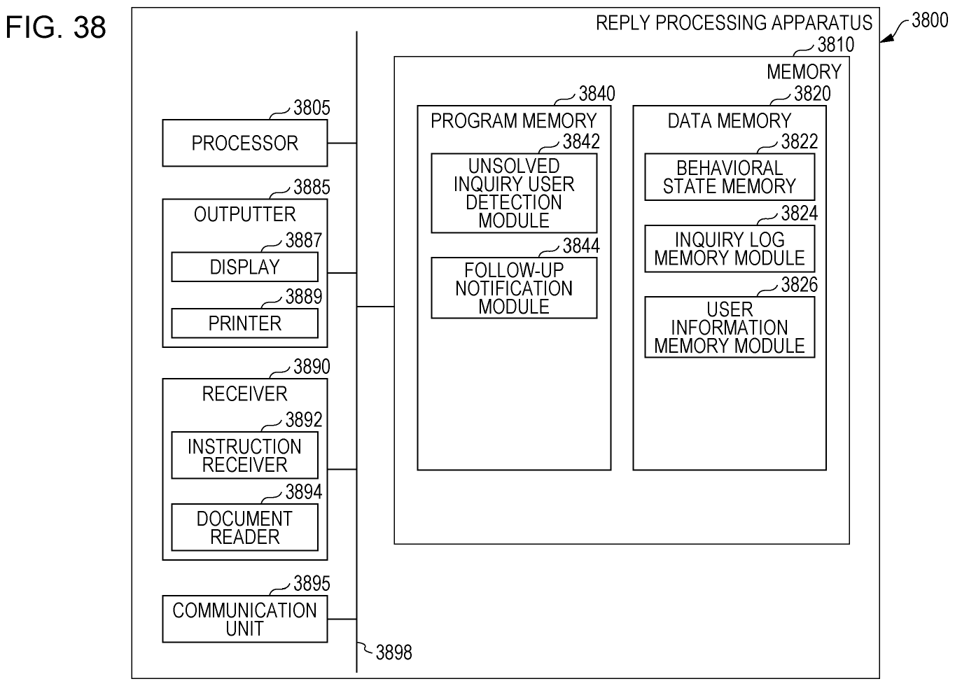

FIG. 38 illustrates a conceptual modular configuration of a structure of a reply processing apparatus 3800 the exemplary embodiment.

The reply processing apparatus 3800 causes the reply processing apparatus 200 to perform the process of the unsolved inquiry user detection module 146 in the information processing apparatus 100. Specifically, the reply processing apparatus 3800 is configured by adding the unsolved inquiry user detection module 146 in the information processing apparatus 100 to the program memory 240 in the reply processing apparatus 200. The information processing apparatus 100 in FIG. 1 performs the process of the unsolved inquiry user detection module 146 on the user terminal side and the reply processing apparatus 200 may perform the same process. Specifically, the modules other than an unsolved inquiry user detection module 3842 and follow-up notification module 3844 in the reply processing apparatus 3800 have functions respectively identical to functions of the modules in the reply processing apparatus 200 having symbol numbers with the same lower two digits.

A program memory 3840 stores the unsolved inquiry user detection module 3842 and follow-up notification module 3844.

The unsolved inquiry user detection module 3842 may receive the information indicating an operation related to the end of the inquiry of the user. If the operation log of the user stored on a behavioral state memory 3822 satisfies the predetermined condition, the unsolved inquiry user detection module 3842 determines that the question in the inquiry of the user has not been solved.

If the unsolved inquiry user detection module 3842 determines that the question in the inquiry of the user has not been solved, the follow-up notification module 3844 may create a document by using the operation log of the user stored on the behavioral state memory 3822 and the inquiry log of the user stored on the inquiry log memory module 3824 and transmit the document to the person in charge of the user. It is noted that the follow-up notification module 3844 has a function identical to the function of the follow-up notification module 242 in FIG. 2. Specifically, the follow-up notification module 242 performs the operation “if the information indicating that the question in the inquiry of the user has not been solved is received from the information processing apparatus 100” while the follow-up notification module 3844 performs the operation “if the unsolved inquiry user detection module 3842 determines that the question in the inquiry of the user has not been solved.” Both the follow-up notification module 242 and the unsolved inquiry user detection module 3842 perform the same operation, namely, creating the document by using the operation log of the user and the inquiry log of the user and transmitting the document to the person in charge of the user.

The program described above may be provided in a recorded form on a recording medium or via a communication medium. The program described above may be construed as a computer readable non-transitory recording medium storing the program.

The non-transitory computer readable medium recording the program refers to as a recording medium that is used to install, execute, and/or distribute the program.

The recording media include digital versatile disk (DVD), compact disk (CD), Blu-ray disc (registered trademark), magnetooptical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transmission medium. The transmission media include a wired network, a wireless network, or a combination thereof. The wired and wireless networks may include a local-area network (LAN), metropolitan-area network (MAN), wide-area network (WAN), the Internet, intranet, and/or extranet. The program in whole or in part may be transmitted over a carrier wave.

The program may be part or whole of another program, or may be stored on the recording medium together with another program. The program may be split and the split programs may then be separately stored on the recording media. The program may be processed in any fashion before being stored as long as the program remains restorable. For example, the program may be compressed or encrypted before storage.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory storing a log of an operation of a user; and
a processor configured to
cause the memory to store the log of the operation of the user, and
if the log of the operation of the user stored on the memory satisfies a specific condition after an operation related to an end of an inquiry of the user is detected, transmit, to an external entity related to a destination of the inquiry, information indicating that a question in the inquiry of the user is not solved.

2. The information processing apparatus according to claim 1, wherein a reply to the inquiry is performed by a robot, and
wherein the specific condition is that an access destination specified in the log of the operation performed by the user stored on the memory includes the destination of the inquiry.

3. The information processing apparatus according to claim 2, wherein the specific condition is that an access destination specified in the log of the operation performed by the user after the end of the inquiry includes the destination of the inquiry.

4. The information processing apparatus according to claim 1, wherein if the specific condition is satisfied, a confirmation as to whether the question in the inquiry of the user is solved is performed on the user, and if a reaction indicating that the question in the inquiry of the user is not solved is detected from the user, information indicating that the question in the inquiry of the user is not solved is transmitted.

5. The information processing apparatus according to claim 4, wherein if the reaction is not received in the confirmation from the user within a specific time period, the information indicating that the question in the inquiry of the user is not solved is transmitted.

6. A reply processing apparatus comprising:
a memory storing a log of an operation of a user and a log of an inquiry of the user; and
a processor configured to,
if information indicating that the question in the inquiry of the user is not solved is received from the information processing apparatus according to claim 1, create a document by using the log of the operation of the user and the log of the inquiry of the user stored on the memory and transmit the document to an entity in charge of the user.

7. An information processing system comprising:
an information processing apparatus; and
a reply processing apparatus,
wherein the information processing apparatus includes:
a memory storing a log of an operation of a user; and
a processor configured to
cause the memory to store the log of the operation of the user, and
if the log of the operation of the user stored on the memory satisfies a specific condition after an operation related to an end of an inquiry of the user is detected, transmit, to an external entity related to a destination of the inquiry, information indicating that a question in the inquiry of the user is not solved, and
wherein the reply information processing apparatus includes:
a memory storing a log of an operation of a user and a log of an inquiry of the user; and
a processor configured to,
if information indicating that the question in the inquiry of the user is not solved is received from the information processing apparatus, create a document by using the log of the operation of the user and the log of the inquiry of the user stored on the memory and transmit the document to an entity in charge of the user.

8. An information processing apparatus comprising:
a memory storing a log of an operation of a user; and
a processor configured to
cause the memory to store the log of the operation of the user, and
if the log of the operation of the user stored on the memory satisfies a specific condition after information indicating that an operation related to an inquiry of the user is performed is received, determine that a question in the inquiry of the user is not solved.

9. The information processing apparatus according to claim 8, wherein the memory stores a log of the inquiry of the user, and
wherein the processor is configured to, if the question in the inquiry of the user is determined to be not solved, create a document by using the log of the operation of the user and the log of the inquiry of the user stored on the memory and transmit the document to an entity in charge of the user.

10. A non-transitory computer readable medium storing a program causing a computer to execute a process for processing a reply, the process comprising:
storing a log of an operation of a user and a log of an inquiry of the user on a memory, and
if information indicating that the question in the inquiry of the user is not solved is received from the information processing apparatus according to claim 1,
creating a document by using the log of the operation of the user and the log of the inquiry of the user stored on the memory and transmitting the document to an entity in charge of the user.
